(19) United States
(12) Patent Application Publication
(10) Pub. No.: US 2026/0200274 A1
(43) Pub. Date: Jul. 16, 2026

(54) HITCH HEAD WITH APPARATUS FOR PIVOTING

(71) Applicant: LKQ Corporation, Antioch, TN (US)

(72) Inventors: Christopher W. Moore, Mishawaka, IN (US); Gahre P. Scudder, Kernersville, NC (US); Lisa McCrory, Elkhart, IN (US)

(73) Assignee: LKQ Corporation, Antioch, TN (US)

(21) Appl. No.: 19/019,321

(22) Filed: Jan. 13, 2025

(51) Int. Cl. B60D 1/24; B60D 1/46; B60D 1/52

(52) U.S. Cl. CPC B60D 1/247; B60D 1/46; B60D 1/52

(57) ABSTRACT

A head is provided for a weight distribution hitch assembly that includes a hitch bar and a weight distribution hitch shank with an upper aperture arrayed above a lower aperture for mounting the head. The head may include a substantially U-shaped bracket with upper and lower pairs of holes to align with, and couple with fasteners, the holes of the hitch shank. The lower pair of holes on the head bracket may be provided with a horizontal dimension allowing the bracket to be pivoted between a first angle and a second angle and to be held in place in each of the angles in a tightened configuration. The fastener for the lower hole may include a bolt spacer with a non-centered hole and a non-centered stud insertable in a first and second configurations corresponding to the first and second angles of the bracket, respectively.

### BACKGROUND

This disclosure relates in general to a device and components for use as a hitch head that is pivotable between angles suited to various configurations for a trailer coupler and frame. The hitch head is particularly suited to be used in conjunction with weight distribution hardware, such as arms, connected between the hitch head and the trailer frame. More specifically, this disclosure relates to devices and components for a hitch head with a selectable pivot angle for coordination with the trailer's coupler's mounting position, e.g., mounted on a top portion of the trailer's frame or mounted to a bottom portion of the trailer's frame.

Hitch heads incorporating weight distribution arms are typically used in connection with a hitch that includes a horizontal shank and a vertical shank. The horizontal shank fits into the hitch receiver of the towing vehicle and the vertical shank includes a series of bolt holes providing a mounting rack for selecting the height of the hitch head relative to the hitch receiver of the vehicle. Such hitch heads may further include hardware for changing a pivot angle of the hitch head relative to the mounting rack, typically requiring some disassembly to accomplish pivoting of the head relative to the vertical shank.

The invention overcomes the problem of disassembling hardware and fasteners to adjust a weight distribution head to correctly align with a trailer, whether the trailer has a coupler mounted onto the top portion of the trailer frame, or the coupler is mounted onto the bottom portion of a trailer frame, or for other reasons related to the. The weight distribution head may include a slotted hole cut into the lower segment of the U-shaped bracket, a circular hole cut into the upper segment of the U-shaped bracket, and a bolt spacer with a non-centered hole and stud. A bolt is installed into the circular hole of the U-shaped bracket, which is secured to the weight distribution head. This allows for the weight distribution head to pivot around an axis defined by the bolt through the circular hole, adjusting its vertical position relative to the hitch shank. The bolt spacer may then be installed on a second bolt and installed into the slotted hole of the U-shaped bracket of the weight distribution hitch head. A person installing or adjusting the weight distribution hitch head can adjust the vertical pivot angle on the weight distribution hitch head to fit either a trailer coupler mounted onto the top portion of a trailer frame, or a trailer coupler mounted onto the bottom portion of a trailer frame by rotating the bolt spacer into the appropriate position of the slotted hole of the weight distribution hitch head to allow for the correct alignment of the weight distribution hitch head to the trailer.

With the bolts and spacer in place the user may also change the pivot angle without disassembly/assembly. The user only needs to loosen the weight distribution hitch head fasteners enough to rotate the bolt spacer and adjust the vertical pivot angle to the desired position. In addition, with the slotted hole in the lower segment of the U-shaped channel of the weight distribution hitch head, extra hardware is eliminated by allowing the weight distribution hitch head to rest against the vertical shank of the hitch and act as its own support.

### SUMMARY

According to an aspect of the present disclosure, a device may include a head for use in a weight distribution hitch assembly, the assembly including a hitch bar and a weight distribution hitch shank providing at least a first and a second horizontal apertures, including an upper aperture arrayed above a lower aperture, for mounting the head. The head may include a body for coupling to the hitch shank, the body including a substantially U-shaped bracket, the bracket including first and second pairs of holes, the holes configured for the first pair of holes to align with the upper aperture and the second pair of holes to align with the lower aperture of the hitch shank. The head may further include a first fastener and a second fastener configured for insertion through the first and second pairs of holes of the bracket and through the upper and lower apertures of the shank to couple the head to the shank. The second pair of holes on the bracket may be provided with a horizontal dimension allowing the bracket to be pivoted between a first angle and a second angle with the second fastener in a loosened configuration and to be held in place in each of the angles with the second fastener in a tightened configuration.

According to another aspect of the present disclosure, a weight distribution hitch assembly may include a hitch bar and a weight distribution hitch shank providing at least a first and a second horizontal apertures, including an upper aperture arrayed above a lower aperture. The assembly may further include a head that includes a body for coupling to the hitch shank, the body including a substantially U-shaped bracket, the bracket including first and second pairs of holes, the holes configured for the first pair of holes to align with the upper aperture and the second pair of holes to align with the lower aperture of the hitch shank. The assembly may further include a first fastener and a second fastener configured for insertion through the first and second pairs of holes of the bracket and through the upper and lower apertures of the shank to couple the head to the shank, The second pair of holes on the bracket may be provided with a horizontal dimension allowing the bracket to be pivoted between a first angle and a second angle with the second fastener in a loosened configuration and to be held in place in each of the angles with the second fastener in a tightened configuration.

According to another aspect of the present disclosure, a head for use in a weight distribution hitch assembly, the assembly including a hitch bar and a weight distribution hitch shank providing at least a first and a second horizontal apertures, including an upper aperture arrayed above a lower aperture, for mounting the head, may include a body for coupling to the hitch shank, the body including a substantially U-shaped bracket, the bracket including first and second pairs of holes, the holes configured for the first pair of holes to align with the upper aperture and the second pair of holes to align with the lower aperture of the hitch shank. The head may further include a first fastener and a second fastener configured for insertion through the first and second pairs of holes of the bracket and through the upper and lower apertures of the shank to couple the head to the shank. The second fastener may include a bolt and a bolt spacer having a stud selectively insertable in one of second pair of holes, the stud insertable in a first configuration corresponding to the first angle of the bracket and the stud insertable in a second configuration corresponding to the second angle of the bracket.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 is a side view of a hitch assembly adjacent to a receiver of a towing vehicle with the hitch assembly including a horizontal shank for installation in the receiver, a vertical shank with an array of mounting positions for a hitch head with trunnions mounted to support weight distribution arms, a support for mounting a hitch ball, and a pair of bolts vertically spaced to attach the head to the shank at a selected height, and a non-centered bolt spacer at the lower bolt for selecting a pivot angle of the head, and also showing an adjustment bolt with a locknut for use in moving and setting the head to the selected pivot angle.

FIG. 2 is a side view of the hitch head of FIG. 1, showing a pair of vertically spaced holes corresponding to the pair of bolts in FIG. 1, the upper hole being circular and the lower hole having an elongated racetrack, or slotted, shape, and showing a hitch ball installed on the support therefor on the head.

FIG. 3 is a partially side and overhead view of the head of FIGS. 1 and 2 without any of the other hardware present, and showing the top of a vertical channel within a U-shaped bracket of the head where the upper and lower holes are visible on a near side of the bracket and an upper hole is visible within the channel on a far side of the bracket, the two upper holes defining an axis about which the head is pivotable, and also showing vertical holes for mounting one of the trunnions and the hitch ball.

FIG. 4 is a directly overhead view of the head as in FIG. 3, showing the U-shaped channel in the bracket of the head.

FIG. 5 is a side view of the hitch assembly of FIG. 1 mounted at a selected height to the vertical shank with only one of the pair of vertically spaced bolts in place, and showing the head pivoted to a lower selected angle with the slotted lower hole of the head aligned at a rearward end with the hole in the vertical shank, and with the base of the adjustment bolt resting against the vertical shank.

FIG. 6 is a partially rotated side view of the hitch assembly of FIG. 5, with the addition of a bolt and bolt spacer positioned in preparation for insertion through the slotted hole at the lower portion of the head.

FIG. 7 is a reverse side view of the bolt spacer of FIG. 6 showing the non-centered hole and the non-centered stud, and showing that the shape and dimensions of the combined hole and stud correspond to the elongated racetrack or slotted shape of the lower hole in the head bracket.

FIG. 8 is a partially rotated view of the bolt spacer of FIG. 7, illustrating the height of the stud for insertion into the slotted hole in the bracket of the head.

FIG. 9 is a cutaway view into the internal structure of the head positioned similarly to FIG. 1, illustrating how the adjustment bolt has a base abutting the vertical shank and is operational to assist in pivoting the head to a selected angle.

FIG. 10 is a side view of the hitch assembly with the head pivoted to a higher position, as shown in FIG. 1, and showing a trailer coupled to the hitch ball, the trailer coupler being positioned at the lower edge of the trailer's frame.

FIG. 11 is a side view of the hitch assembly with the head pivoted to a lower position as shown in FIG. 5, and showing a trailer coupled to the hitch ball, the trailer coupler being positioned at the upper edge of the trailer's frame, and demonstrating how shifting the bolt spacer in the slotted hole while the bolts are in place and loosened is accomplished.

FIG. 12 is a side, close up view of a forward portion of the hitch head of FIG. 1, showing the pivot point in the upper hole and an example of dimensions for the lower hole and for the range of the pivot angle, and showing the adjustment bolt that facilitates movement of the head over the range of the pivot angle.

In the appended figures, similar components and/or features may have the same reference number or the same number with a letter suffix.

### DETAILED DESCRIPTION

The following detailed description of some exemplary embodiments of the present disclosure do not limit the scope, applicability, or configuration of the other embodiments that will be understood from the present disclosure. The ensuing description will provide those skilled in the art with an enabling description not only for the exemplary embodiment but also other embodiments within the scope of the present disclosure. It is understood that various changes may be made in the function and arrangement of elements without departing from the spirit and scope as set implementing forth in the appended claims.

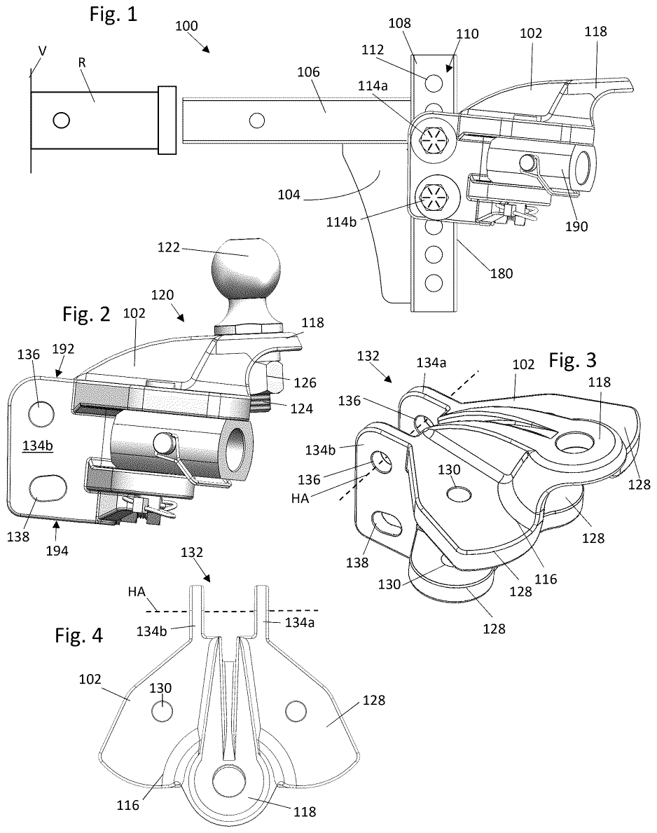

As shown in FIGS. 1-12, a weight distribution hitch assembly 100 may include a head 102 and a hitch bar 104. A typical construction for hitch bar 104 is a horizontal shank 106 welded at one end, or otherwise permanently coupled to, a vertical shank 108. The shanks may be formed of any suitable material, such as rectangularly-cross-sectioned steel bars. Horizontal shank 106 may be sized and shaped to fit into a receiver R on a towing vehicle V.

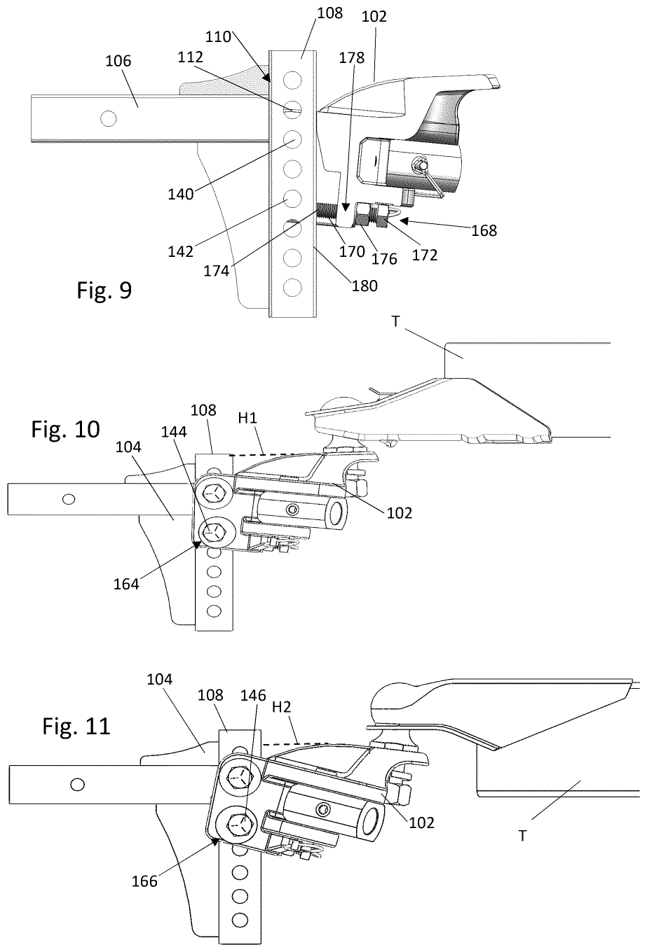

Hitch assembly 100 may be configured for operation with varying heights of towing vehicle V and a trailer T. For example, as best seen in FIG. 9, vertical shank 108 is provided with an array 110 of apertures, such as eight evenly spaced circular horizontal holes 112. Head 102 may be selectively coupled to a pair of holes 112 of vertical shank 108 by a suitable fastener, e.g., by a pair of bolts 114a and 114b, and additional hardware as will be further described below.

Head 102 may be made by any suitable method, for example by casting or by welding steel components to provide a body 116 with suitable features. Head 102 typically includes a support 118 at a rearward portion 120 for mounting a means for attaching to trailer T, e.g., a hitch ball 122 (see e.g., FIG. 2) held in place by an integral bolt 124 and a nut 126. Head 102 may include two pairs of opposed horizontal flanges 128, one pair on each side of support 118, and each flange 128 may be provided with a vertical hole 130. Holes 130 on each side may be vertically aligned for mounting a trunnion 190 for connection of arms (not shown) for distribution of the weight of trailer T.

Body 116 may include a substantially U-shaped bracket 132, which may include a pair of opposed vertical flanges 134a and 134b, as best seen in FIGS. 3 and 4. Bracket 132 may include a first pair of aligned holes 136, one in each of vertical flanges 134a and 134b in an upper segment 192 of bracket 132. Bracket 132 may include a second pair of aligned holes 138, one in each of vertical flanges 134a and 134b in a lower segment 194 of bracket 132. Hole pairs 136 and 138 are generally vertically aligned with one another and spaced apart to correspond to spacing between holes 112 on vertical shank 108. The spacing of the hole pairs 136, 138 may be sufficient to span one or more of shank holes 112, e.g., spanning two holes 112 as seen in FIGS. 1, 5, and 6. More generally, hole pairs 136, 138 are configured for the first pair of holes 136 to align with an upper aperture 140 and for the second pair of holes 138 to align with a lower aperture 142 of shank 108 (See FIGS. 6 and 9).

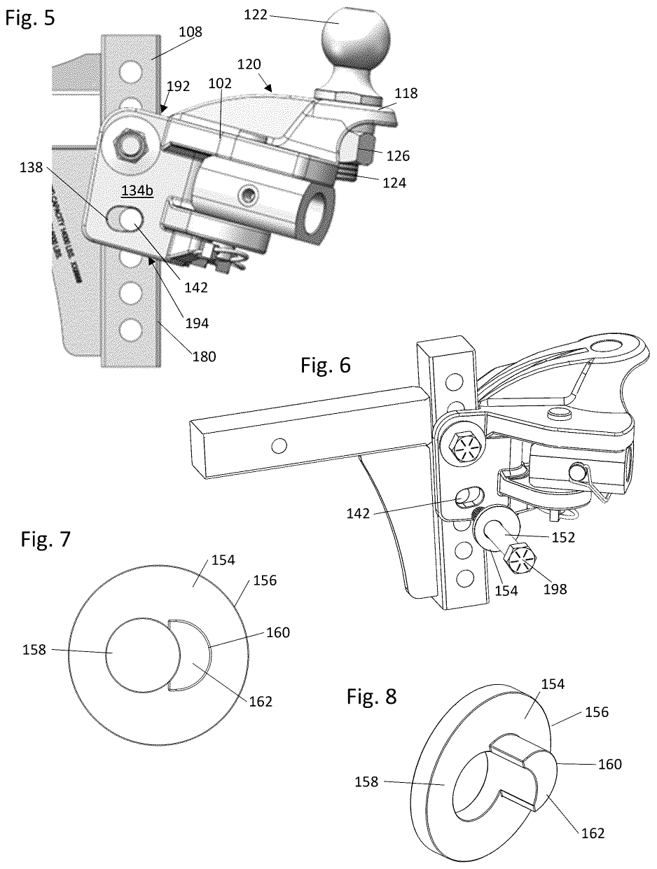

As best seen in FIGS. 3 and 5, the pair of upper holes 138 may be aligned to define a horizontal axis HA. Head 102 may be pivotable about axis HA to provide for a vertical movement of head 102 and support 118 and a hitch ball mounted thereon.

As noted above, first fastener 114a and second fastener 114b are configured for insertion through the first and second pairs of holes 136, 138, respectively, of bracket 132 and through upper and lower apertures 140, 142 of shank 108 to couple head 102 to shank 108. Typically, hole 136 has a diameter 150, which is substantially equal to, but slightly greater than a diameter 152 of fasteners 114a, 114b, to allow for insertion, rotation, and removal of the fastener 114a. Typically fasteners 114a, 114b have the same diameter.

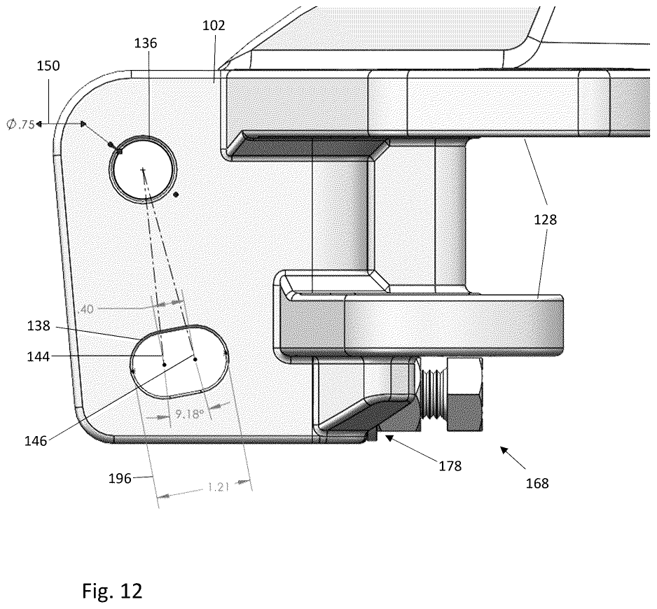

To allow bracket 132 to be pivoted between a first angle 144 (see, e.g., FIGS. 10 and 12) and a second angle 146 (see, e.g., FIGS. 11 and 12) second pair of holes 138 on bracket 132 may each be a slotted hole 148, or have an elongated, racetrack shape, or otherwise be provided with a horizontal dimension 196 that is greater than a width or diameter 152 of fastener 114b. For example, fastener 114b may be a bolt 198 with diameter 152 (FIG. 6) while horizontal dimension 196 of holes 138, as best seen in FIG. 12, may be greater. For example, bolt 198 may have a diameter 152 of about 0.75″ and horizontal dimension 196 may be about 1.21″ and this may provide for about 0.4″ of pivoting movement of head 102 at hole 138. This may provide for dimension 196 to be about 61% greater than dimension 152, or as another example in a range of between about 20% and 100% greater than diameter 152.

Second fastener 114b may include in addition to bolt 198 a bolt spacer 154 (FIGS. 7 and 8) that may include a generally washer-shaped body 156 with a non-centered hole 158 and a stud 160, which may also be non-centered and extend from one side of body 156. As best seen in FIGS. 6, 10, and 11, stud 160 may be configured for insertion in one of the second pair of holes 138 on one side of bracket 132. Another bolt spacer 154 may be provided for insertion in the other of the pair of holes 138 on the other side of bracket 132. Non-centered stud 160 may be provided with a substantially crescent shape 162. Bolt spacer 154 may be seen by consideration of FIGS. 6-8 to provide in the combination of non-centered hole 158 and non-centered stud 160 with crescent shape 162, to provide a shape and dimensions corresponding to the elongated racetrack or slotted shape of lower hole 138 in head bracket 132.

Stud 160 may be insertable in a first configuration 164 (FIG. 10) corresponding to first angle 144 of bracket 132 and alternatively insertable in a second configuration 166 (FIG. 11) corresponding to second angle 146 (FIG. 11) of bracket 132. Bracket 132 may be selectively switchable between the two configurations without removal of either of the first or second fastener from bracket 132. That is, with the first and second fastener in a loosened configuration, and in particular with second fastener 114b sufficiently loosened to withdraw bolt spacer 154 from hole 138, the spacer may be rotated between configurations 164 and 166 and reinserted in the hole. Bracket 132 may held in place in each of the angles with the fasteners in a tightened configuration. As also seen in FIGS. 10 and 11, in first configuration 164, head 102 may be at height H1 relative to vertical shank 108 and in second configuration 166, head 102 may be at height H2 relative to vertical shank 108. A typical difference between H1 and H2 may be about 0.4″ and a range of between about 0.1″ and about 0.7″.

Head 102 may include an adjustment structure 168, such as an adjustment bolt 170 with a hex head 172, an opposite end 174 and a locknut 176 for moving head 102 between the first pivot angle and the second pivot angle, with locknut 176 providing for fixing bolt 170 in place. The adjustment bolt may be inserted in a threaded hole 178 in head 102. Bolt end 174 may be configured to bear on a surface 180 of vertical shank 108, with movement of head 102 accomplished by rotation of bolt 170 in threaded hole 178 with end 174 bearing on shank surface 180 to move head 102 between the first pivot angle and the second pivot angle.

The range of the pivot between the first and second angle may be of any scope as best suited to the particular application of head 102. For example, the range may be about 9.18° as seen in FIG. 12, or about 9.2°, or about 9°, or within a range of about 8° to 10°, or within a range of about 5° to 13°, or within a range of about 1° to 20°, or other angles as suited to the application.

Thus, a non-centered retaining bolt, i.e., the combination of bolt 114b and spacer 154 may provide for a multi position weight distribution head. A user installing or adjusting the weight distribution hitch head may adjust the vertical pivot angle on the weight distribution hitch head to fit either a trailer coupler mounted onto the top portion of a trailer frame, or a trailer coupler mounted onto the bottom portion of a trailer frame by rotating the bolt spacer into the correct position of the slotted hole of the weight distribution hitch head to allow for the correct alignment of the weight distribution hitch head to trailer. The slotted hole cut into the lower segment head's mounting bracket and the bolt spacer with the non-centered hole and stud and the bolt in the circular hole in the upper segment of the bracket allow for the weight distribution head to pivot in a vertical direction from the circular hole in the weight distribution hitch head. The user's selecting the correct position of the weight distribution hitch head allows for the correct alignment of the weight distribution hitch head to trailer.

Specific details are given in the above description to provide a thorough understanding of the embodiments. However, it is understood that the embodiments may be practiced without these specific details. For example, structures be shown in simplified diagrams in order not to obscure the embodiments in any detail. In other instances, well-known processes, structures, and techniques may be shown without unnecessary detail in order to avoid obscuring the embodiments.

While the principles of the disclosure have been described above in connection with specific apparatuses and methods, it is to be clearly understood that this description is made only by way of example and not as limitation on the scope of the disclosure.

What is claimed is:

1. A head for use in a weight distribution hitch assembly, the assembly including a hitch bar and
a weight distribution hitch shank providing at least a first and a second horizontal apertures, including an upper aperture arrayed above a lower aperture, for mounting the head, the head comprising:
a. a body for coupling to the hitch shank, the body including a substantially U-shaped bracket, the bracket including first and second pairs of holes, the holes configured for the first pair of holes to align with the upper aperture and the second pair of holes to align with the lower aperture of the hitch shank;
b. a first fastener and a second fastener configured for insertion through the first and second pairs of holes of the bracket and through the upper and lower apertures of the shank to couple the head to the shank;
wherein the second pair of holes on the bracket is provided with a horizontal dimension allowing the bracket to be pivoted between a first angle and a second angle with the second fastener in a loosened configuration and to be held in place in each of the angles with the second fastener in a tightened configuration.

2. The head of claim 1 wherein the second hole on the bracket is a slotted hole.

3. The head of claim 1 wherein the second fastener includes a bolt defining a diameter and wherein the horizontal dimension of the second pair of holes is at least about 20% greater than the diameter of the bolt.

4. The head of claim 1 wherein the second fastener includes a bolt defining a diameter and wherein the horizontal dimension of the second pair of holes is no more than about 100% greater than the diameter of the bolt.

5. The head of claim 1 wherein the second fastener includes a bolt and further including a bolt spacer wherein the bolt spacer includes a stud for insertion in one of second pair of holes, the stud insertable in a first configuration corresponding to the first angle of the bracket and the stud insertable in a second configuration corresponding to the second angle of the bracket.

6. The head of claim 5 wherein the bolt spacer defines a circular shape with a non-centered hole.

7. The head of claim 6 wherein the stud of the bolt spacer is non-centered relative to the circular space.

8. The head of claim 5 wherein the stud defines a crescent shape.

9. The head of claim 1 further including an adjustment structure for moving the head between the first pivot angle and the second pivot angle.

10. The head of claim 9 wherein the adjustment structure includes a bolt defining a head and an end opposite the head, the bolt inserted in a threaded hole in the head, the end configured to bear on a surface of the hitch shank, the head operable for rotation of the bolt in the threaded hole with the end bearing on the hitch shank surface to move the head between the first pivot angle and the second pivot angle.

11. A weight distribution hitch assembly, the assembly comprising:
a. a hitch bar and a weight distribution hitch shank providing at least a first and a second horizontal apertures, including an upper aperture arrayed above a lower aperture;
b. head that includes a body for coupling to the hitch shank, the body including a substantially U-shaped bracket, the bracket including first and second pairs of holes, the holes configured for the first pair of holes to align with the upper aperture and the second pair of holes to align with the lower aperture of the hitch shank;
c. a first fastener and a second fastener configured for insertion through the first and second pairs of holes of the bracket and through the upper and lower apertures of the shank to couple the head to the shank;
wherein the second pair of holes on the bracket is provided with a horizontal dimension allowing the bracket to be pivoted between a first angle and a second angle with the second fastener in a loosened configuration and to be held in place in each of the angles with the second fastener in a tightened configuration.

12. The hitch assembly of claim 11 wherein the second hole on the bracket is a slotted hole.

13. The hitch assembly of claim 11 wherein the second fastener includes a bolt defining a diameter and wherein the horizontal dimension of the second pair of holes is at least about % greater than the diameter of the bolt.

14. The hitch assembly of claim 11 wherein the second fastener includes a bolt defining a diameter and wherein the horizontal dimension of the second pair of holes is no more than about % greater than the diameter of the bolt.

15. The hitch assembly of claim 11 wherein the second fastener includes a bolt and further including a bolt spacer defining a circular shape, and wherein the bolt spacer includes a non-centered hole to receive the bolt and a non-centered stud adjacent the non-centered hole, the stud selectively insertable in one of second pair of holes, the stud insertable in a first configuration corresponding to the first angle of the bracket and the stud insertable in a second configuration corresponding to the second angle of the bracket.

16. The hitch assembly of claim 15 wherein the stud defines a crescent shape.

17. The hitch assembly of claim 11 further including an adjustment bolt for moving the head between the first pivot angle and the second pivot angle, wherein the adjustment bolt defines a head and an end opposite the head, the bolt including a threaded portion inserted in a threaded hole in the head, the end configured to bear on a surface of the hitch shank, the head operable for rotation of the bolt in the threaded hole with the end bearing on the hitch shank surface to move the head between the first pivot angle and the second pivot angle.

18. A head for use in a weight distribution hitch assembly, the assembly including a hitch bar and
a weight distribution hitch shank providing at least a first and a second horizontal apertures, including an upper aperture arrayed above a lower aperture, for mounting the head, the head comprising:
a. a body for coupling to the hitch shank, the body including a substantially U-shaped bracket, the bracket including first and second pairs of holes, the holes configured for the first pair of holes to align with the upper aperture and the second pair of holes to align with the lower aperture of the hitch shank;
b. a first fastener and a second fastener configured for insertion through the first and second pairs of holes of the bracket and through the upper and lower apertures of the shank to couple the head to the shank; wherein the second fastener includes a bolt and further including a bolt spacer having a stud selectively insertable in one of second pair of holes, the stud insertable in a first configuration corresponding to the first angle of the bracket and the stud insertable in a second configuration corresponding to the second angle of the bracket.

19. The head of claim 18 wherein the bolt spacer defines a circular shape, and wherein the bolt spacer includes a non-centered hole to receive the bolt, the stud being non-centered relative to the circular shape and adjacent the non-centered hole.

20. The hitch assembly of claim 18 wherein the stud defines a crescent shape.
